(19) United States
(12) Patent Application Publication
(10) Pub. No.: US 2026/0302878 A1
(43) Pub. Date: Oct. 1, 2026

(54) Rotor Shaft for a Machine, Connection Tube for a Rotor Shaft, and Machine Having Same

(71) Applicant: Bayerische Motoren Werke Aktiengesellschaft, Muenchen (DE)

(72) Inventors: Rene Hayder, Strengberg (AT); Wilfried Barth, Saxen (AT); Andreas Wagner, St. Valentin (AT)

(21) Appl. No.: 19/476,086

(22) PCT Filed: Apr. 4, 2024
(86) PCT No.: PCT/EP2024/059153

§ 371 Date: Oct. 16, 2025

(30) Foreign Application Priority Data
Apr. 18, 2023 (DE) 10 2023 109 654.0

(51) Int. Cl. H02K 7/00

(52) U.S. Cl. CPC H02K 7/003

(57) ABSTRACT

A rotor shaft has coaxial outer and inner tubes, a hollow shaft journal, and a connection tube. A first space is formed between an inner and outer wall of the inner tube. The inner tube has an inner tube wall opening. The hollow shaft journal has a first journal portion projecting out of the outer tube, and a second journal portion that is arranged coaxially in the outer tube, is spaced apart from the inner tube, and is fixedly connected in terms of rotation to the outer tube inner wall. A first connection tube end bears sealingly against a shaft journal inner wall in the first journal portion. The connection tube extends through and projects out of the second journal portion, and leads sealingly into the inner tube. A space that communicates with the first space is formed between a connection tube outer wall and a shaft journal inner wall.

The present application is the U.S. national phase of PCT Application PCT/EP2024/059153 filed on Apr. 4, 2024, which claims priority of German patent application No. 10 2023 109 654.0 filed on Apr. 18, 2023, the entire contents of which are incorporated herein by reference.

### TECHNICAL FIELD

The present disclosure relates to the field of machines having rotor shafts.

### BACKGROUND

In order to ensure an optimal operation of an electric drive machine or traction machine, cooling as efficient as possible is essential during the operation of the traction machine. In particular, operating states of the traction machine in which a control of the traction machine only provides a throttled drive torque are designed to be avoided in order to prevent an undesired overheating of components of the traction machine. If such an operating state arises, a user of the traction machine, in particular a driver of a motor vehicle provided with the traction machine, can no longer rely on the usual full power of the traction machine; the user is surprised by the reduction/throttling of the drive torque (which is called degradation) and suddenly has to manage with the reduced power. This can lead to problems in overtaking maneuvers, hilly terrain or uphill travel, trailer towing, etc. There is also the need to avoid as far as possible such operating states which require a cooling of the traction machine with maximum efficiency. Machines whose rotor shaft is cooled internally by means a cooling fluid are known from the prior art, for example from DE 949 611 B, from DE 10 2012 217 361 A1 or from DE 10 2014 204 133 A1.

There is a need, therefore, for a solution in order to cool a rotor shaft of a machine, in particular, an electric machine, even more efficiently.

### SUMMARY

The above-described need, as well as others, are addressed by at least some embodiments disclosed herein. Features, advantages and possible embodiments which are set forth in the course of the description for one of the subjects of the independent claims are to be regarded across categories and embodiments at least analogously as features, advantages and possible embodiments of the respective subject of the other independent claims and any possible combination of the subjects of the independent claims, if applicable in combination with one or more of the dependent claims.

A first embodiment is a rotor shaft for a machine which, amongst other things, has a connection tube (which can also be denoted as a coolant lance). One or more embodiments further relate to the connection tube alone, and to a machine which has the rotor shaft and, as a result, the connection tube. At least one embodiment is a motor vehicle which has the machine and, as a result, the rotor shaft having the connection tube. This means that a constituent part of the rotor shaft is formed by the connection tube in the intended installed position thereof, wherein the rotor shaft in the intended installed position thereof forms a constituent part of the machine. As soon as the machine is arranged in the intended installed position thereof, it forms a constituent part of the motor vehicle. The machine is configured, in particular, as an electric traction machine for the motor vehicle, which means that the motor vehicle is designed as a purely electrically or hybrid-electrically driven motor vehicle.

In at least one embodiment, the rotor shaft has an outer tube which is designed, for example, to support a rotor core of the electric machine fixedly in terms of rotation on the outside. Thus, in the case of the machine, an outer circumferential surface of the outer tube and a rotor of the machine are connected to one another fixedly in terms of rotation. The rotor shaft has an inner tube in the hollow interior of the outer tube, wherein the outer tube and the inner tube are arranged coaxially to one another. In other words, a longitudinal center axis of the outer tube and a longitudinal center axis of the inner tube coincide, and namely with a longitudinal center axis of the rotor shaft. The inner tube is mounted in the outer tube such that an outer tube annular space is formed between an outer tube inner wall of the outer tube and an inner tube outer wall of the inner tube. In addition, the inner tube has an inner tube wall opening or a plurality of inner tube wall openings, wherein the respective inner tube wall opening fully penetrates an inner tube wall of the inner tube parallel to the radius or obliquely to the radius. As a result, the hollow interior of the inner tube and the hollow interior of the outer tube or the hollow interior of the inner tube and the outer tube annular space communicate with one another. In particular, the inner tube has a conical inner tube base which forms one of the ends of the inner tube and has axial grooves, the groove base thereof and the outer tube inner wall being radially spaced apart from one another so that axial channels are configured between the inner tube base and the outer tube inner wall. Moreover, the inner tube is centrally mounted in the outer tube by means of the inner tube base, since an external diameter of the inner tube on the inner tube base-compared to the remaining inner tube-has the dimension of an inner diameter of the outer tube. Thus the hollow interior of the inner tube and the outer tube annular space communicate both by means of the inner tube wall openings and by means of the grooves or channels of the inner tube base.

In addition, the rotor shaft has a hollow shaft journal which has a first and a second shaft journal portion which are fixedly connected to one another. In particular, the shaft journal portions are configured in one piece with one another. The first journal portion projects out of the outer tube and thus forms an output element of the rotor shaft or the machine. For example, a spur gear ring is arranged fixedly in terms of rotation on the first journal portion of the hollow shaft journal, which spur gear ring is designed to mesh with a spur gear external to the machine, namely with an input spur gear of a transmission flanged to the machine. The second journal portion of the hollow shaft journal is arranged coaxially in the outer tube, i.e. in the hollow interior of the outer tube, and is spaced apart from the inner tube along the longitudinal center axis of the rotor shaft. The second journal portion and the outer tube inner wall are connected to one another sealingly and fixedly in terms of rotation.

As a result, the outer tube annular space is limited or defined by the outer tube inner wall, the inner tube outer wall, a front annular face of the second journal portion and an inner tube base. The shaft journal has a journal wall opening or a plurality of journal wall openings on the second journal portion, wherein the respective journal wall opening fully penetrates a shaft journal wall of the shaft journal parallel to the radius or obliquely to the radius. As a result, the hollow interior of the shaft journal and an output-side orifice of the outer tube, from which the first journal portion projects out of the outer tube, communicate with one another.

The connection tube of the rotor shaft is configured, in at least some embodiments, from plastics, for example as a plastics injection-molded part, and has a first connection tube end which bears sealingly, at its outer circumferential side, against a shaft journal inner wall in the first journal portion. Moreover, the connection tube extends through the second journal portion, wherein it projects out of the second journal portion. Since the connection tube projects out of the second journal portion, it leads into the inner tube, wherein a sealed connection prevails between the inner tube and the connection tube. A shaft journal annular space is formed between the connection tube outer wall and the shaft journal inner wall in the second journal portion, wherein the shaft journal annular space and the outer tube annular space communicate with one another or are connected to one another. A longitudinal center axis of the connection tube and the longitudinal center axes of the outer tube, the inner tube and the shaft journal coincide with the longitudinal center axis of the rotor shaft.

This arrangement of the outer tube, the inner tube, the path, through which a coolant, in particular an oil, can flow. During the operation of the machine provided with the rotor shaft, the coolant is fed into the hollow interior 41 the shaft journal. To this end, an inflow line of a coolant or oil module is fluidically coupled to a shaft journal orifice, i.e. to the hollow interior, of the shaft journal. For example, a hollow connecting piece can be inserted, in particular pressed, into the shaft journal orifice, wherein a radial shaft seal is provided between the inflow line and the shaft journal orifice, which radial shaft seal prevents an escape of the coolant or oil at the coupling point between the inflow line and the shaft journal. The oil is driven, for example, by means of a pump of the coolant or oil module through the inflow line and thereby into the shaft journal and, as a result, into the rotor shaft.

The oil flows through the shaft journal and thereupon enters the connection tube, since this connection tube bears sealingly with its first connection tube end against the shaft journal inner wall in the first journal portion, whereby an escape of the oil between the shaft journal and the connection tube is prevented. The oil continues to flow through the connection tube and then flows out of the connection tube, whereby it flows into the inner tube since the connection tube leads into the inner tube. The oil then passes through the inner tube wall opening or openings out of the inner tube and thereby between the inner and the outer tube, i.e. into the outer tube annular space. Moreover, the oil flows out of the inner tube into the outer tube annular space by means of the grooves or channels arranged on the inner tube base.

The size and number of the respective inner tube wall opening or the respective groove are configured such that a large part of the oil located in the inner tube flows via the inner tube wall opening or openings into the outer tube annular space, wherein a substantially smaller part of the oil located in the inner tube flows into the outer tube annular space via the groove or grooves. An end edge of the inner tube or inner tube base is spaced apart from a closure element of the rotor shaft, so that the oil flows out of the inner tube at the end edge, flows into the channels/grooves and thus flows into the outer tube annular space. In the outer tube annular space, the oil passes along the outer tube inner wall where it absorbs and, as a result, transports away heat which is generated during the operation of the machine. As the heated oil flows out of the outer tube annular space, it flows between the connection tube outer wall and the shaft journal inner wall, i.e. into the shaft journal annular space, from where the oil flows through the journal wall opening or openings and finally through the output-side orifice of the outer tube, out of the rotor shaft. In particular, the rotor shaft leads into a transmission chamber of a transmission flanged to the machine by means of the output-side orifice of the rotor shaft. It is provided, in particular, that the coolant which is used for cooling the machine and a lubricant which is used for lubricating the transmission are identical. In other words: the coolant circuit described herein can be a constituent part of a lubricant circuit of an arrangement comprising the machine and the transmission.

Due to the rotor shaft it is possible to direct the oil or coolant flow particularly efficiently to the points/components of the rotor shaft or machine which have a particularly high cooling requirement. This ensures the particularly efficient heat dissipation of the components and the machine is reliably protected from overheating. In particular, when the machine is used as the electric traction machine in the motor vehicle, a degradation operation of the machine is effectively avoided.

In one implementation, it is provided that the connection tube has on the connection tube outer wall thereof a centering rib arrangement through which fluid can flow along the longitudinal center axis and by means of which the connection tube is coaxially mounted in the second journal portion. The centering rib arrangement has three or more centering ribs, wherein the respective centering rib projects radially outwardly out of the connection tube outer wall. In the rotor shaft, the connection tube outer wall and the shaft journal inner wall are thus spaced apart from one another over a height of the respective centering rib, wherein the centering rib arrangement is arranged in the shaft journal annular space or at least extends therein. The centering ribs are equally spaced apart from one another in an outer circumferential direction of the connection tube, so that firstly oil can flow between the centering ribs and secondly the connection tube is centrally mounted in a particularly secure manner in the shaft journal.

According to at least some embodiments, it is provided that the connection tube has on the connection tube outer wall thereof an abutment collar through which fluid can flow along the longitudinal center axis and by means of which the connection tube abuts against a front annular face of the second journal portion. In this manner, during the operation of the machine, the connection tube is prevented from being inadvertently disengaged from its intended installed position and, for example, from migrating too far into the shaft journal. In addition, an assembly of the rotor shaft is simplified. The abutment collar comprises an abutment element or a plurality of abutment elements, wherein the respective abutment element is brought to bear directly against the front annular surface of the second journal portion in the axial direction, i.e. along the longitudinal center axis of the rotor shaft. If the abutment collar has two or more abutment elements, they are equally spaced apart from one another in the outer circumferential direction of the connection tube, so that firstly oil can flow through between the abutment elements and secondly the connection tube is axially fastened in a particularly secure manner to the shaft journal or the front annular surface thereof. In particular, the centering rib arrangement and/or the abutment collar is/are configured in one piece or integrally with the connection tube. This means that during a primary molding, in particular injection molding, of the connection tube, the centering rib arrangement and/or the abutment collar is/are formed therewith during the primary molding.

According to one or more embodiments, the connection tube has a first sealing ring seat at the first connection tube end. In this context, the rotor shaft has a first sealing ring which is fixed in the first sealing ring seat and, as a result, between the shaft journal inner wall in the first journal portion and the connection tube outer wall. Thus the fluidically sealed connection between the connection tube and the hollow interior of the shaft journal is particularly reliable. In addition, the output-side orifice of the outer tube and the shaft journal annular space are sealed from one another in a particularly secure manner.

At least some implementations provide a connecting sleeve, the connection tube and the inner tube being sealingly connected to one another thereby, since the connecting sleeve encompasses or encloses a second connection tube end facing the inner tube and an inner tube end facing the connection tube at its outer circumferential side. An outer diameter of the connecting sleeve is smaller than an inner diameter of the outer tube so that the outer tube inner wall and the connecting sleeve are radially spaced apart from one another. In this manner, the connecting sleeve is arranged in the outer tube annular space and oil flows around the connecting sleeve on the outside during operation. Due to the connecting sleeve, the connection tube and the inner tube are particularly stable and are sealingly connected to one another in a reliable manner.

According to at least one embodiment, the connection tube has at the second connection tube end a second sealing ring seat. In this context, the rotor shaft has a second sealing ring which is fixed in the second sealing ring seat. If the rotor shaft has the above-described connecting sleeve, it is provided in particular that the second sealing ring, which is seated in the second sealing ring seat, is inserted between the connection tube outer wall and a connecting sleeve inner wall of the connecting sleeve. Thus the fluidically sealed connection, which the connecting sleeve provides between the connection tube and inner tube, is sealed in a particularly reliable and particularly sealed manner. Due to the first and/or the second sealing ring, the outer tube annular space and the shaft journal annular space are particularly securely sealed relative to the respective hollow interior of the shaft journal, the connection tube and the inner tube, which assists a particularly efficient cooling of the rotor shaft.

The cooling of the rotor shaft is carried out even more efficiently during the operation of the machine when-as a further possible embodiment provides-the outer tube inner wall has a surface enlargement structure in the outer tube annular space. The surface enlargement structure has, for example, a plurality of annular grooves and/or annular notches which are spaced apart from one another equidistantly or which are directly adjacent to one another. Thus a plurality of recesses is formed, wherein the respective recess extends in the radial direction from the outer tube inner wall in the direction of an outer tube outer wall. In this embodiment, due to the surface enlargement structure the outer tube annular space has a particularly extensive outer tube inner wall of the outer tube, whereby during the operation of the machine a particularly large amount of oil simultaneously passes directly along the material of the outer tube. As a result, at a given flow rate of the oil, a particularly large amount of heat can be transported away from the outer tube.

Further features can be found in the claims, the figures and the description of the figures. The features and combinations of features mentioned above in the description and the features and combinations of features shown below in the description of the figures and/or in the figures alone are not only able to be used in the respectively specified combination but also in other combinations or alone without departing from the scope of the invention.

### BRIEF DESCRIPTION OF THE DRAWINGS

FIG. 1 shows a sectional view of a machine which has a rotor shaft with a connection tube,

FIG. 2 shows a sectional view of the connection tube and

FIG. 3 shows a perspective view of the connection tube.

### DETAILED DESCRIPTION

A rotor shaft 1 for a machine 2, a connection tube 3 of the rotor shaft 1, the machine 2 and a motor vehicle (not shown) having the machine 2 are explained hereinafter in a joint description. Elements which are the same and functionally the same are provided with the same reference signs in the figures.

The connection tube 3 forms a constituent part of the rotor shaft 1, wherein this rotor shaft forms a constituent part of the machine 2 in the intended installed position thereof (as shown in the figures). The machine 2 is configured in the present case as an electric traction machine, wherein the motor vehicle has the traction machine 2 as a purely electrically or hybrid-electrically driven motor vehicle.

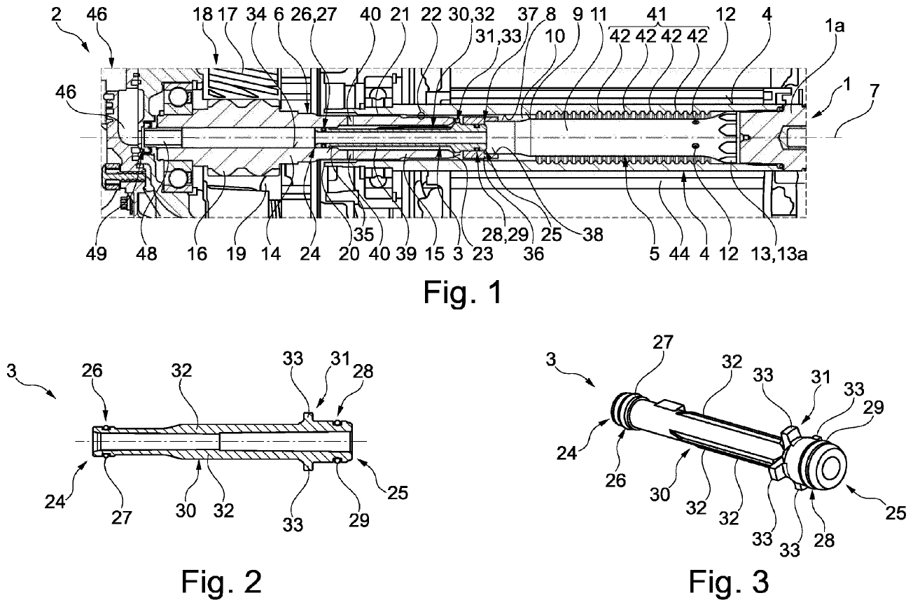

FIG. 1 shows a sectional view of the machine 2, the rotor shaft 1 thereof having the connection tube 3 and an outer tube 4, an inner tube 5 and a hollow shaft journal 6. The outer tube 4 and the inner tube 5 are arranged coaxially to one another relative to a longitudinal center axis 7 of the rotor shaft 1, wherein an outer tube annular space 10 is formed between an outer tube inner wall 8 and an inner tube outer wall 9. The outer tube annular space 10 and a hollow inner space 11 of the inner tube communicate with one another, since the inner tube has an inner tube wall opening 12, in the present case two or more inner tube wall openings 12. The inner tube wall openings 12 are arranged in the vicinity of a conical inner tube base 13 of the inner tube 5 via which the inner tube 5 is mounted in a centered manner in the outer tube 4. On the conical inner tube base 13, which forms a first end of the inner tube 5, an outer diameter of the inner tube 5 is widened relative to the remaining inner tube 5, and namely up to the dimension of an inner diameter of the outer tube 4 so that the inner tube 5 bears via the inner tube base 13 thereof against the outer tube inner wall 8. In an outer circumferential direction of the inner tube base 13, it has axially arranged grooves 13a, the respective groove base thereof and the outer tube inner wall 8 being radially spaced apart from one another. Thus the grooves 13a and the outer tube inner wall 8 form axial channels with one another. An end edge of the inner tube 5 or inner tube base 13 is spaced apart from a closure element la of the rotor shaft 1.

The hollow shaft journal 6 has a first journal portion 14 and a second journal portion 15 which in the present case are configured in one piece with one another. The first journal portion 14 in the example here supports a spur gear ring 16 which is fixed in terms of rotation and which meshes with a machine-external input spur gear 17 of a transmission 18 flanged to the machine 2 in the transmission chamber 19 thereof. The first journal portion 14 projects out of an output-side orifice 20 of the outer tube 4 and thereby into the transmission chamber 19. The journal portions 14, 15 transition into one another at a press-fit element 21 of the shaft journal 6, wherein the shaft journal 6 is pressed into the outer tube 4 by means of the press-fit element 21. In order to block a relative rotation between the shaft journal 4 and the outer tube 4, in the present case a splined toothing 22 is arranged between the shaft journal 6 and the outer tube 4. The splined toothing 22 is arranged, in particular, on the second journal portion 15 which is arranged coaxially in the outer tube 4. In this manner, the second journal portion 15 and the outer tube inner wall 8 are connected to one another sealingly and fixedly in terms of rotation. A front annular face 23 of the second journal portion 15 and the inner tube 5 are spaced apart from one another via a linear spacing along the longitudinal center axis 7 of the rotor shaft 1.

The connection tube 3—which is shown in FIG. 2 and FIG. 3 in isolation in one respective view—has a first connection tube end 24 and a second connection tube end 25. In the present case, a first sealing ring seat 26 is arranged at the first connection tube end 24, a first sealing ring 27 being seated in the first sealing ring seat in the rotor shaft 1. In the present case, a second sealing ring seat 28 is arranged at the second connection tube end 25, a second sealing ring 29 being seated in the second sealing ring seat in the rotor shaft 1. In the example here, the connection tube 3 has between the ends 24, 25 a centering rib arrangement 30 and an abutment collar 31 which are designed in each case so that fluid can flow through. The centering rib arrangement 30 has three or more, in the example here four, centering ribs 32, wherein the abutment collar has at least one abutment element 33, in the present example four abutment elements 33.

In FIG. 1 it can be identified that the connection tube 3 is arranged between the shaft journal 6 and the inner tube 5, the first connection tube end 24 thereof bearing sealingly, at its outer circumferential side, against a shaft journal inner wall 34 of the shaft journal 6 in the first journal portion 14. In the present case, the first sealing ring 27 which is seated in the first sealing ring seat 26 is clamped between the shaft journal inner wall 34 and a connection tube outer wall 35. In other words, the first sealing ring 27 is fixed by means of the first sealing ring seat 26 between the shaft journal inner wall 34 in the first journal portion 14 and the connection tube outer wall 35. The connection tube 3 extends through the second journal portion 15 and is coaxially mounted by means of the centering rib arrangement 30 or centering ribs 32 in the second journal portion 15. The connection tube 3 abuts against the front annular surface 23 of the second journal portion 15 via the abutment collar 31 or abutment element 33 thereof. Moreover, the connection tube 3 projects out of the second journal portion 15 and thus bridges the spacing via which the second journal portion 15 and the inner tube 5 are spaced apart from one another. The connection tube 3 at its second connection tube end 25 leads sealingly into the inner tube 5 or into the hollow interior 11 thereof. In the present example, the connection tube 3 and the inner tube are sealingly connected to one another by means of a connecting sleeve 36 which encloses the second connection tube end 25 and an inner tube end 37 facing the connection tube 3 at its outer circumferential side. The second sealing ring 29 is fixed between the connection tube outer wall 35 and a connecting sleeve inner wall 38 of the connecting sleeve 36 by means of the second sealing ring seat 28. A shaft journal annular space 39 that communicates with the outer tube annular space 10 is formed between the connection tube outer wall 35 and the shaft journal inner wall 34 in the second journal portion 15. On the first journal portion 14 the shaft journal 6 has a journal wall opening 40, in the present case two or more journal wall openings 40 via which the shaft journal annular space 39 and the output-side orifice 20 of the outer tube 4 communicate with one another. The output-side orifice 20, which in the example here leads into the transmission chamber 19 and the shaft journal annular space 39, are fluidically sealed relative to one another at the outer circumferential side of the shaft journal 6, in this case by means of the press-fit element 21.

It also emerges from FIG. 1 that according to the present example the outer tube inner wall 8 has a surface enlargement structure 41 which has a plurality of annular notches 42 in the outer tube annular space 10. The annular notches 42 form in each case a recess which extends in the radial direction from the outer tube inner wall 8 in the direction of the outer tube outer wall 43. Since the machine 2 is an electric machine in this case, a rotor core 44 is fastened fixedly in terms of rotation to the outer tube outer wall 43.

During the operation of the machine 2, the coolant, which is configured in particular as oil, is fed into the shaft journal 6. To this end, an inflow line 45 of a coolant or oil module 46 is fluidically coupled to a shaft journal orifice 47 of the shaft journal 6. In the example here, a hollow connecting piece 48 is pressed into the shaft journal orifice 47, wherein a radial shaft seal 49 is provided between the inflow line 47 and the shaft journal orifice 47. The oil is driven by means of a pump of the coolant or oil module 16 through the inflow line 45 and thus into the shaft journal 6, whereupon the oil flows through the shaft journal 6 and enters the connection tube 3. The oil continues to flow through the connection tube 3 and then out of the connection tube, i.e. into the inner tube. Then the oil flows through the inner tube wall openings 12 and through the channels 13a out of the inner tube and thereby into the outer tube annular space 10. There the oil passes along the outer tube inner wall 8, in particular along the surface enlargement structure 41, where it absorbs and transports away heat which is generated during the operation of the machine 2. The heated oil flows out of the outer tube annular space 10 into the shaft journal annular space 39, from where it flows through the journal wall openings 40 and finally through the output-side orifice 20 of the outer tube 4 out of the rotor shaft 1. Since in the example here the rotor shaft 1 leads into the transmission chamber 19 of the transmission 18 by means of the output-side orifice 20, the oil flowing out of the rotor shaft 1 enters the transmission chamber 19.

The rotor shaft 1, in particular the connection tube 3 thereof, the machine 2 and the motor vehicle show one respective possibility of how a rotor shaft of a machine, in particular an electric machine, can be cooled even more efficiently. One advantage of this embodiment is to ensure a targeted flow control of the cooling medium oil in thermally highly stressed zones of the rotor shaft 1 by means of the component topology described herein. In this manner, heat is optimally discharged from the system in a targeted manner, thereby avoiding an overheating of the rotor and, as a result, a degradation operation of the machine 2.

### LIST OF REFERENCE SIGNS

1 Rotor shaft
1a Closure element
2 Machine
3 Connection tube
4 Outer tube
5 Inner tube
6 Shaft journal
7 Longitudinal center axis
8 Outer tube inner wall
9 Inner tube outer wall
10 Outer tube annular space
11 Interior of inner tube
12 Inner tube wall opening
13 Inner tube base
13a Groove
14 First journal portion
15 Second journal portion
16 Spur gear ring
17 Input spur gear
18 Transmission
19 Transmission chamber
20 Output-side orifice
21 Press-fit element
22 Splined toothing
23 Front annular surface
24 First connection tube end
25 Second connection tube end
26 First sealing ring seat
27 First sealing ring
28 Second sealing ring seat
29 Second sealing ring
30 Centering rib arrangement
32 Centering rib
33 Abutment element
34 Shaft journal inner wall
35 Connection tube outer wall
36 Connecting sleeve
37 Inner tube end
38 Connecting sleeve inner wall
39 Shaft journal annular space
40 Journal wall opening
41 Surface enlargement structure
42 Annular notches
43 Outer tube outer wall
44 Rotor core
45 Inflow line
46 Coolant or oil module
47 Shaft journal orifice
48 Connecting piece
49 Radial shaft seal

1.-10. (canceled)

11. A rotor shaft for a machine having,
an outer tube,
an inner tube which is arranged coaxially in the outer tube, wherein an outer tube annular space is formed between an outer tube inner wall and an inner tube outer wall, and the inner tube has an inner tube wall opening,
a hollow shaft journal, a first journal portion thereof projecting out of the outer tube, wherein a second journal portion of the shaft journal is arranged coaxially in the outer tube, is spaced apart from the inner tube along a longitudinal center axis of the rotor shaft and is connected sealingly and fixedly in terms of rotation to the outer tube inner wall and has a journal wall opening,
a connection tube, a first connection tube end thereof bearing sealingly, at an outer circumferential side, against a shaft journal inner wall in the first journal portion, wherein the connection tube extends through the second journal portion, projects out of the second journal portion and, leads sealingly into the inner tube, wherein a shaft journal annular space that communicates with the outer tube annular space is formed between a connection tube outer wall and a shaft journal inner wall in the second journal portion.

12. The rotor shaft as claimed in claim 11, wherein the connection tube has on the connection tube outer wall thereof a centering rib arrangement through which fluid can flow along the longitudinal center axis and such that the connection tube is coaxially mounted in the second journal portion.

13. The rotor shaft as claimed in claim 12, wherein the connection tube has on the connection tube outer wall an abutment collar through which fluid can flow along the longitudinal center axis and such that the connection tube abuts against a front annular face of the second journal portion.

14. The rotor shaft as claimed in claim 13, wherein the connection tube has a first sealing ring seat at the first connection tube end, wherein a first sealing ring is fixed in the first sealing ring seat and between the shaft journal inner wall in the first journal portion and the connection tube outer wall.

15. The rotor shaft as claimed in claim 11, wherein the outer tube inner wall has a surface enlargement structure in the outer tube annular space.

16. The rotor shaft as claimed in claim 11, wherein the connection tube has on the connection tube outer wall an abutment collar through which fluid can flow along the longitudinal center axis and such that the connection tube abuts against a front annular face of the second journal portion.

17. The rotor shaft as claimed in claim 11, wherein the connection tube has a first sealing ring seat at the first connection tube end, wherein a first sealing ring is fixed in the first sealing ring seat and between the shaft journal inner wall in the first journal portion and the connection tube outer wall.

18. The rotor shaft as claimed in claim 17, wherein the connection tube is sealingly connected to the inner tube using at least in part a connecting sleeve that encompasses a second connection tube end facing the inner tube and an inner tube end facing the connection tube at an outer circumferential side thereof.

19. The rotor shaft as claimed in claim 18, wherein the connection tube has at the second connection tube end a second sealing ring seat in which a second sealing ring is fixed.

20. The rotor shaft as claimed in claim 19, wherein the second sealing ring is fixed between the connection tube outer wall and a connecting sleeve inner wall of the connecting sleeve.

21. The rotor shaft as claimed in claim 11, wherein the connection tube is sealingly connected to the inner tube using at least in part a connecting sleeve that encompasses a second connection tube end facing the inner tube and an inner tube end facing the connection tube at an outer circumferential side thereof.

22. The rotor shaft as claimed in claim 11, wherein the outer tube inner wall has a surface enlargement structure in the outer tube annular space.

23. A machine for a motor vehicle having a rotor shaft configured as claimed in claim 11.

24. A motor vehicle having the machine as claimed in claim 23.

25. A connection tube for the rotor shaft as claimed in claim 11.
